(19) United States
(12) Patent Application Publication
(10) Pub. No.: US 2005/0283456 A1
(43) Pub. Date: Dec. 22, 2005

(54) Systems and methods for building a disk image

(76) Inventors: Christoph J. Graham, Houston, TX (US); Tri M. Nguyen, Cypress, TX (US); Timothy S. Terry, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/872,259

(22) Filed: Jun. 18, 2004

(51) Int. Cl. G06F 17/30

(52) U.S. Cl. 707/1

(57) ABSTRACT

In one embodiment, a system and a method for creating a disk image pertain to receiving identification of individual files to be used to create the disk image, creating file system structures within an output file, and appending the identified files to the output file to obtain a complete disk image.

### BACKGROUND

When a computer system crashes, it is necessary to restore or recover the computer system. This is typically accomplished by reinstalling all of the files and directories that comprise the “disk image” that was originally provided on the computer system. Before that can be done, however, the user must obtain a copy of the disk image.

Disk images are normally created using recovery utilities that are configured to generate a mirror copy of the disk image of a similar, properly-functioning computing system. For instance, a user, as a precaution, may use one such utility to create a backup disk for his or her computer before a system crash occurs. Unfortunately, not all users take such precautionary measures. In such a case, the user may need to obtain an appropriate recovery image from another source, such as the computer manufacturer. The computer manufacturer may create such disk images and make them available for download to users, for instance over the Internet.

Manufacturers can create disk images for their computers using utilities similar to those described above. However, that practice comprises attendant disadvantages. As a first matter, such utilities require the existence of an actual, physical storage device from which to obtain the disk image. Therefore, the manufacturer may need to create the desired disk image from another computer at the build center. Unfortunately, situations may arise in which such a computer is not available. For instance, if it is early in the computer development process, such a computer simply may not exist. In such a case, no disk image can be created using the existing recovery utilities, either for backup purposes or for laying down disk images on new computers during production. In other situations, computer development may be complete and production may have already begun, but the storage devices used in those computers are not available (e.g., they are on order from a memory manufacturer).

Disadvantages exist even when the subject computer is available. For example, when a disk image is created based upon an existing computer, the disk image is geometry-specific, i.e., the image reflects the geometry of the original computer's storage device (e.g., hard disk, flash media, etc.). This can create problems when the created disk image is to be installed on a computer having a different storage device geometry. For instance, if the storage medium of the original computer had 256 megabytes (MB) of available space, but a storage medium used in later productions of the computer actually only has 240 MB of available space (e.g., due to use of a storage medium manufactured by another company), it may not be possible to recover the later-produced computers using the disk image created from the original computer.

Furthermore, specific attributes of the original image will be transferred over to the new disk image. For example, any fragmentation or unused space present in the original disk image will be copied such that the new disk image will comprise that same fragmentation and/or unused space. This is disadvantageous in terms of both performance and space optimization.

### SUMMARY

In one embodiment, a system and a method for creating a disk image pertain to receiving identification of individual files to be used to create the disk image, creating file system structures within an output file, and appending the identified files to the output file to obtain a complete disk image.

### BRIEF DESCRIPTION OF THE DRAWINGS

The systems and methods of this disclosure can be better understood with reference to the following drawings. The components in the drawings are not necessarily to scale.

FIG. 1 is a schematic view of an embodiment of a system with which disk images can be built.

FIG. 2 is a block diagram of an embodiment of a user computer shown in FIG. 1.

FIG. 3 is a block diagram of an embodiment of a server computer shown in FIG. 1.

FIG. 4 is a flow diagram that illustrates an embodiment of building a disk image.

FIGS. 5A and 5B provide a flow diagram that illustrates an embodiment of operation of a disk image builder shown in FIG. 2.

FIG. 6 is a flow diagram that illustrates a method for building a disk image.

### DETAILED DESCRIPTION

Disclosed are systems and methods through which disk images can be created that are available for use in computer build and/or recovery scenarios. As is described in greater detail in the following, disk images having arbitrary geometries can be generated to support sector-based computer system building and recovery. Given that the disk images are created from collections of files, as opposed to actual, physical storage devices of existing computing systems, the images comprise virtual disk images that may be installed on a variety of computer system geometries.

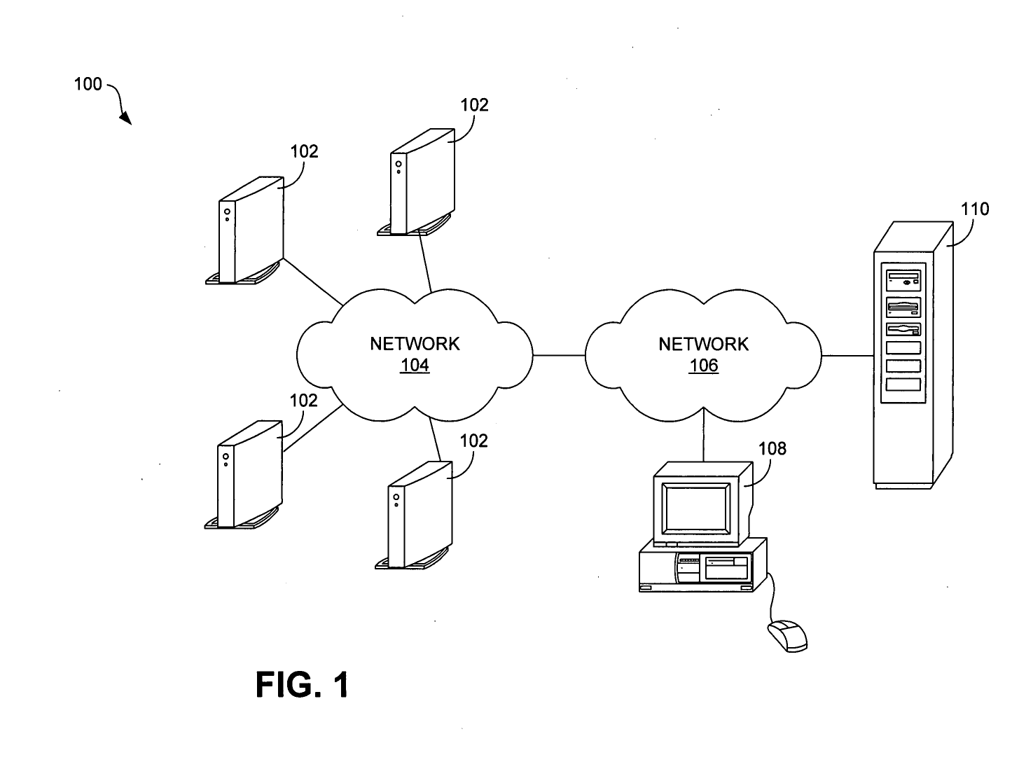

Referring now in more detail to the figures in which like numerals identify corresponding parts, FIG. 1 illustrates an example system 100. As indicated in this figure, the system 100 generally comprises one or more computing devices 102 for which disk images are to be created, either for the purpose of building the devices during production or for recovering lost disk images. For the purposes of this example, it is assumed that the computing devices 102 are possessed by customers, and the disk images are being created at least for the purpose of image recovery.

By way of example, the computing devices 102 comprise terminal computers that include embedded operating systems stored in re-writable, solid-state (e.g., flash) memory. Although terminal computers have been specifically identified, the computing devices 102 could, alternatively, comprise other types of computers such as personal computers (PCs), workstations, notebook computers, or any other type of computer that comprises a disk image.

Each of the computing devices 102 is connected to a first network 104 that, for example, comprises a wide area network (WAN) that forms part of the public Internet. Linked to the first network 104 is a second network 106 that for example, comprises a local area network (LAN) of the manufacturer of the computing devices 102.

Connected to the second network 106 is a user computer 108 that coordinates the disk image creation process, which is described in greater detail below. By way of example, the user computer 108 comprises a personal computer (PC) that is operated by build team member employed by the manufacturer. Also connected to the second network 106 is a server computer 110, which comprises directories and files that are used to create the disk images. Therefore, the server computer 110, when provided, serves as a source of files used to construct disk images for the computing devices 102.

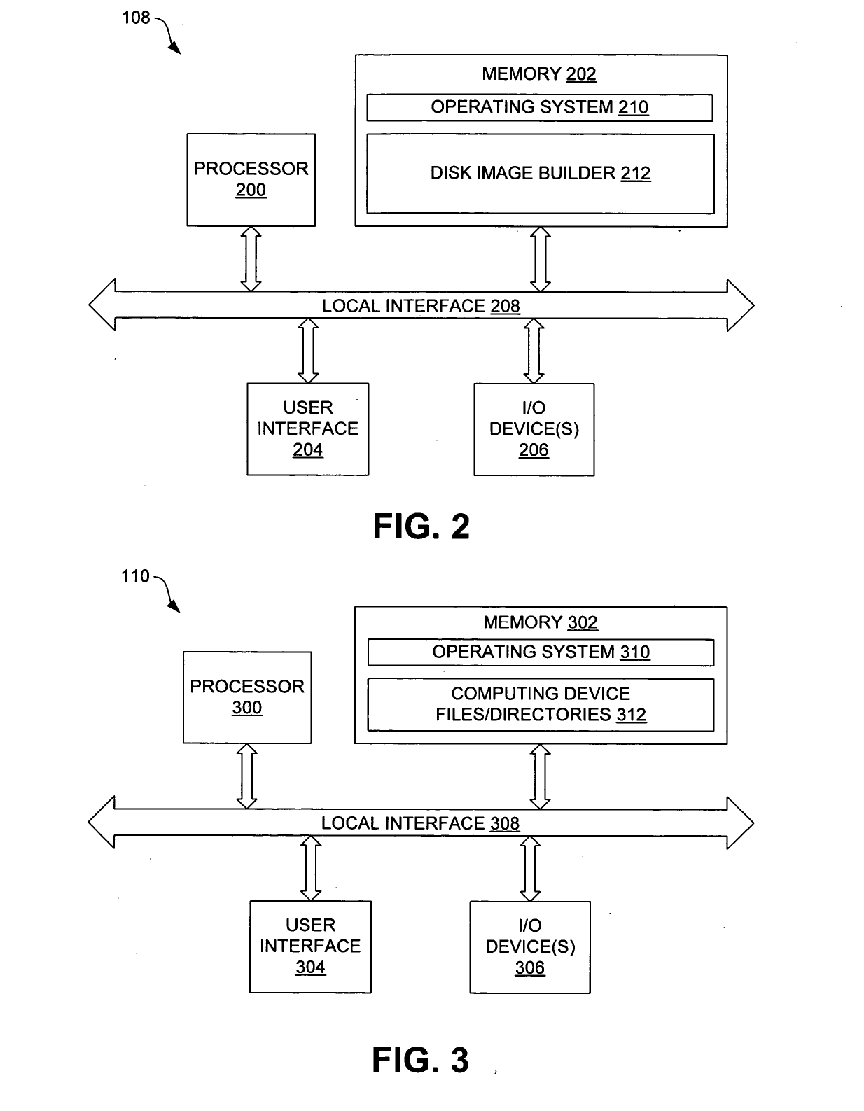

FIG. 2 is a block diagram illustrating an example architecture for the user computer 108 shown in FIG. 1. As is indicated in FIG. 2, the user computer 108 comprises a processor 200, memory 202, a user interface 204, and one or more input/output (I/O) devices 206, each of which is connected to a local interface 208.

The processor 200 can include any custom-made or commercially-available processor, a central processing unit (CPU), an auxiliary processor among several processors associated with the user computer 108, or a semiconductor-based microprocessor (in the form of a microchip). The memory 202 includes one or more volatile memory elements (e.g., read access memory (RAM)) and one or more nonvolatile memory elements (e.g., hard disk).

The user interface 204 comprises those components with which a user can directly interact with the user computer 108. Those components can comprise components that are typically used in conjunction with a PC, such as a keyboard, a mouse, and a display.

The one or more I/O devices 206 comprise the components used to facilitate connection of the user computer 108 to other devices and therefore, for example, comprise one or more serial, parallel, small system interface (SCSI), or universal serial bus (USB), or IEEE 1394 connection elements. In addition, the I/O devices 206 comprise the components used to transmit and/or receive data over a network (e.g., network 106, FIG. 1) such as, for example, a network card or modem.

The memory 202 comprises various programs including an operating system (O/S) 210 and a disk image builder 212. The O/S 210 controls the execution of other programs and provides scheduling, input-output control, file and data management, memory management, and communication control and related services.

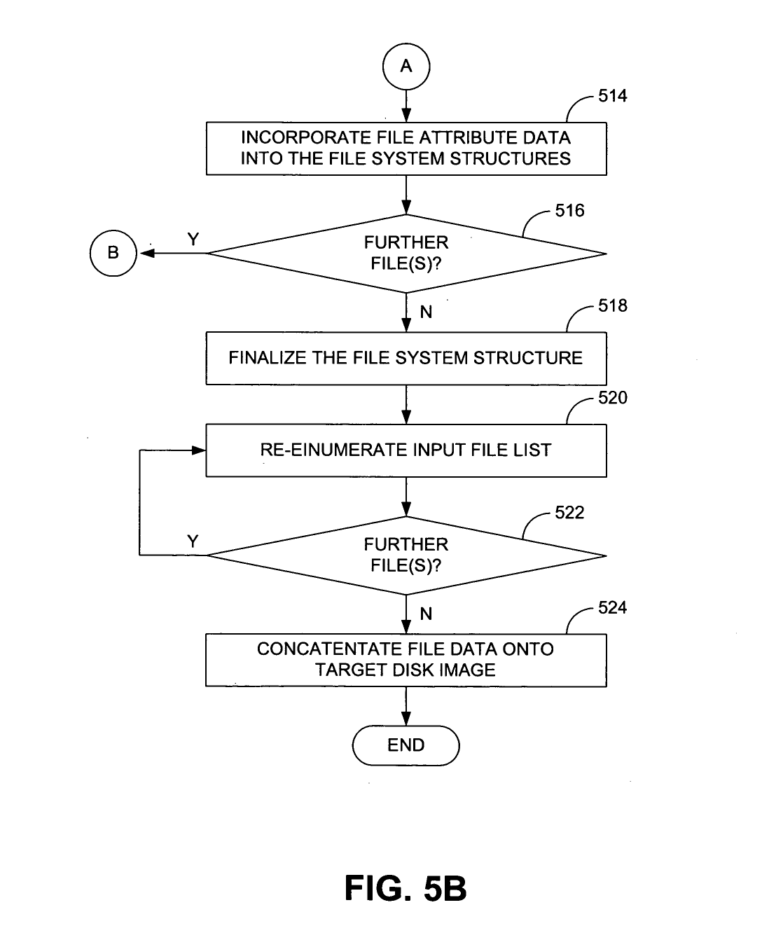

The disk image builder 212 is a program that is configured to aid the build team member (or other user) in creating an installable, sector-based disk image from a collection of available files, as opposed to an existing disk image stored on a computer system storage medium. Such files can reside on the user computer 108 (not indicated in FIG. 2), or another source accessible to the user computer (e.g., the server computer 110). By way of example, the disk image builder 212 is specifically configured to generate disk images for terminal computers that include embedded operating systems stored in re-writable, solid-state (e.g., flash) memory. Operation of the disk image builder 212 is specifically described with reference to FIGS. 5A-5B.

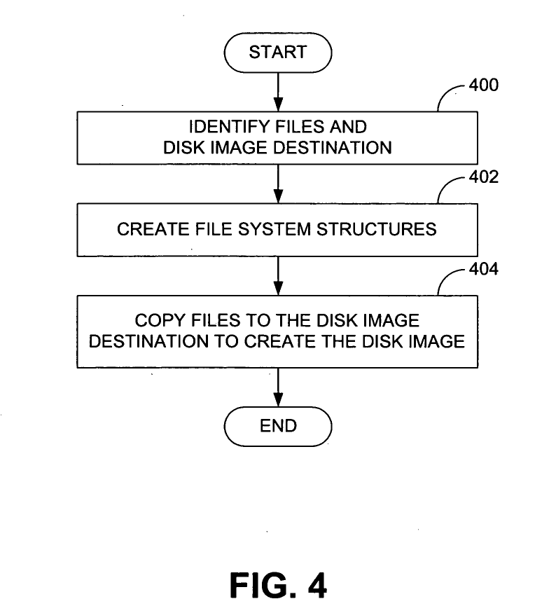

FIG. 3 is a block diagram illustrating an example architecture for the server computer 110 shown in FIG. 1. As is indicated in FIG. 3, the server computer 110, like user computer 108, comprises a processor 300, memory 302, a user interface 304, and one or more I/O devices 306, each of which is connected to a local interface 308.

The processor 300 can include any custom-made or commercially-available processor, a central processing unit (CPU), an auxiliary processor among several processors associated with the server computer 110, or a semiconductor-based microprocessor (in the form of a microchip). The memory 302 can include any one or a combination of volatile memory elements (e.g., RAM) and nonvolatile memory elements (e.g., hard disk, tape, etc.).

The user interface 304 and the one or more I/O devices 306 can, for example, be the same as or similar to the like-named components described above with reference to FIG. 2.

The memory 302 normally comprises at least an O/S 310 and computing device files and directories 312 that are made available (e.g., to the user computer 108) in the disk image build process. Together, the various files and directories comprise the entirety of the components necessary to build a complete disk image.

Various programs (i.e., logic) have been described above. It is to be understood that those programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, examples of the disk image building process will now be discussed. In the discussions that follow, flow diagrams are provided. Any process steps or blocks in these flow diagrams may represent modules, segments, or portions of code that include one or more executable instructions for implementing specific logical functions or steps in the process. Although particular example process steps are described, alternative implementations are feasible. For instance, some steps may be executed out of order from that shown and discussed depending on the functionality involved.

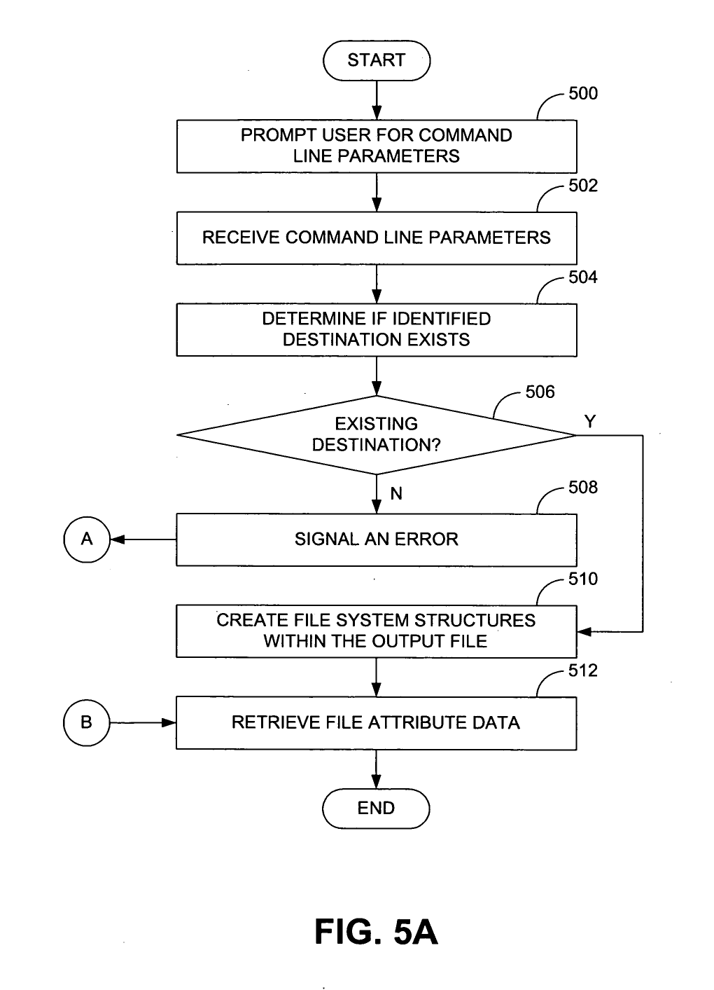

FIG. 4 provides an overview of an example method for building a disk image. Beginning with block 400, the user (e.g., a build team member) identifies files that are to be included in the disk image, and also identifies the disk image destination, i.e., the location in which the disk image is to be created. As noted above, the files can be resident on the user's computer (e.g., computer 108, FIG. 2), or can be provided at another location that is accessible to the user (e.g., computer 110, FIG. 3). The disk image destination can, for example, comprise a location on the user computer's hard disk.

Next, with reference to block 402, the file system structures are built. By way of example, this process is partially or completely automated by the disk image builder (e.g., builder 212, FIG. 2). The structures, file system data and disk layout data, and the file data itself make up the entirety of the disk image. In the case of FAT16 or FAT32, the file system structures include a file allocation table (FAT), a root directory, etc. In other embodiments, the file system structures can include a master file table (MFT), volume bitmap(s), indices, journal and security information, or other system structures, as is in the NT file system (NTFS). Once the file system structures are constructed, a template or shell exists that can be populated with the various files that will comprise the disk image.

With reference then to block 404, files are copied to the disk image destination to create the disk image. The resulting disk image can then be laid down on computing devices during production, or can be provided to users (e.g., customers) to facilitate recovery of lost disk images.

FIGS. 5A and 5B describe an example of operation of the disk image builder 212 shown in FIG. 2. Beginning with block 500 of FIG. SA, the image builder 212, once having been initiated, prompts the user for command line parameters. Such parameters comprise the directory or directories that contain the various files that are to be used to construct the disk image, as well as the output file in which the disk image is to be created. By way of example, the directories are contained within a separate server computer (e.g., computer 110), although they could, alternatively, be contained within the computer on which the image builder 212 executes (e.g., computer 108).

As the parameters are entered by the user, the image builder 212 receives the parameters, as indicated in block 502. Once the parameters have been received, the image builder 212 can determine if the disk image destination (i.e., output file destination) that the user identified exists (i.e., is accessible and available), as is indicated in block 504. Referring next to decision element 506, if the image builder 212 determines that the destination does not exist, the image builder signals an error, as indicated in block 508, and flow is terminated (see FIG. 5B) for the present build attempt.

If the destination is determined to exist, however, flow continues to block 510 at which the image builder 100 creates the file system structures within the output file. As described above, the structures can, for instance, include a master boot record, a root directory, and any other structures necessary to create a template or shell for the files that will be used to define the disk image

Once the framework of the disk image has been constructed with file system structures, the image builder 212 retrieves file attribute data, as indicated in block 512, for the purpose of incorporating that data into the file system structures, as indicated in block 514 of FIG. 5B. In this process, the image builder 212 iterates through the files one-by-one, reading each file block to determine the files' attributes. Once such attributes are determined, data about the attributes is inserted into the system structures. This data can comprise, for example, file names, date and time stamps, file sizes, security attributes (e.g., read only), file types, etc.

As the file attribute data is incorporated into the file system structures, the image builder 212 can determine whether there are further files to read, as indicated in decision block 516. If so, flow returns to block 512 of FIG. 5A, and continues in the manner described above. Once all files have been read and the attribute data associated with those files has been incorporated into the file system structures, flow continues to block 518 at which the image builder 212 finalizes the file system structures. The finalization process comprises performing the steps necessary to update the target directory to reflect the additions made in the file attribute addition process. Accordingly, the process may include, for instance, updating information concerning the amount of free space that is available and the occupied sectors, and finalizing the file mapping entries (e.g., FAT table for FAT16/FAT32, MFT for NTFS).

Next, the image builder 212 re-enumerates the input file list, as indicated in block 520. In that process, the image builder 212 reads each file from the file source block-by-block and appends those blocks (and therefore the files) to the disk image destination or target image. This process continues until each of the files from the file source is copied into the target image (decision block 522). Notably, because individual files are copied in this process, as opposed to an copying existing disk image residing on a physical storage medium, the files provided in the target image are not fragmented. The file order can optionally be specified by the user. For example, the files can be specified directly on one or more command lines (through executing the tool once or multiple time). Alternatively, if a directory is specified, the order is obtained from the source file system. Therefore, command line syntax takes precedence over the source file system order. To cite an example, if the user specifies “Buildimage.exe <targetfile> <source1> <source2> <source3>” in the command line, this case order is implied by the command line. If source1, source 2 or source3 are directories containing files, then the order of the individual files would be carried by parsing the directory entries.

Once all files have been re-enumerated, the image builder 212 concatentates the file data within the target image, as indicated in block 524, to append the files to one another. After the files have been linked together in that manner, a complete disk image results that can be used during computer device building or recovery. The disk image is equivalent to a virtual disk that can be used with other utilities (e.g., recovery utilities) that have no knowledge of the image file system.

Because the above-described processes do not require copying an existing image from an actual, physical storage medium, certain advantages may be realized. For example, because the disk image is created from a collection of individual files, empty spaces that may exist in a given disk image are not recreated. Accordingly, relatively small disk images can be created that can be applied to a wider range of target storage devices. In addition, because the files in the disk image are not fragmented, system performance can be improved. Furthermore, the resultant disk image is geometry-independent, thereby facilitating easier migration to various destination geometries.

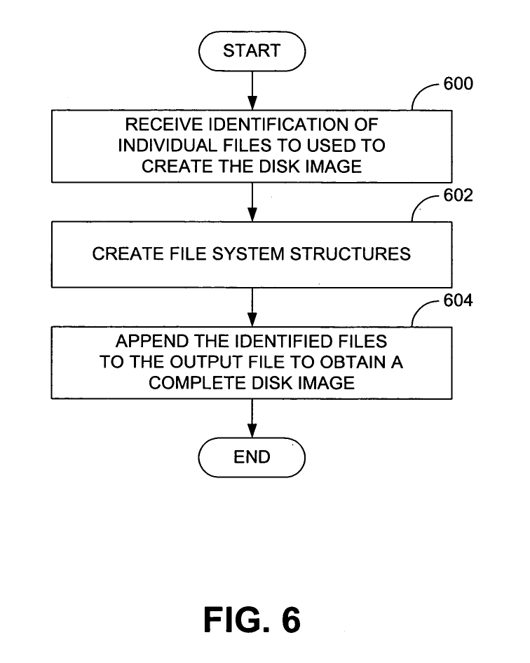

FIG. 6 illustrates a further method for building a disk image including receiving identification of individual files to be used to create the disk image (block 600), creating file system structures within an output file (block 602), and appending the identified files to the output file to obtain a complete disk image (block 604).

1. A method for building a disk image, the method comprising:
receiving identification of individual files to be used to create the disk image;
creating file system structures within an output file; and
appending the identified files to the output file to obtain a complete disk image.

2. The method of claim 1, wherein receiving identification of individual files comprises receiving identification of at least one directory that comprises the files.

3. The method of claim 1, wherein receiving identification of individual files comprises receiving identification of files that do not comprise part of an existing disk image.

4. The method of claim 1, wherein creating file system structures includes creating at least one of a file allocation table, a master boot record, and a root directory.

5. The method of claim 1, wherein appending the identified files to the output file comprises reading each identified file and copying file blocks to the output file.

6. The method of claim 1, wherein appending the identified files to the output file comprises copying the files to the output file such that the files are not fragmented.

7. The method of claim 1, wherein appending the identified files to the output file comprises copying the files to the output file such that blank spaces are not formed in the output file.

8. The method of claim 1, further comprising receiving identification of the output file in which the disk image is to be created.

9. The method of claim 1, further comprising inserting file attribute data into the file system structures including at least one of file names, file types, and file sizes.

10. A system for building a disk image, the system comprising:
means for creating file system structures within an output file; and
means for copying individual files separate from an existing disk image to the output file to generate a sector-based disk image.

11. The system of claim 10, wherein the means for creating file system structures include means for creating at least one of a file allocation table, a master boot record, and a root directory.

12. The system of claim 10, wherein the means for copying individual files comprise means for reading each identified file and copying file blocks to the output file.

13. The system of claim 10, further comprising means for receiving identification of the individual files to use to create the disk image.

14. The system of claim 10, further comprising means for receiving identification of the output file in which the disk image is to be created.

15. The system of claim 10, further comprising means for inserting file attribute data into the file system structures.

16. A disk image builder stored on a computer-readable medium, the builder comprising:
logic configured to receive identification of files separate from an existing disk image;
logic configured to receive identification of an output file in which a new disk image is to be created;
logic configured to creating file system structures within the output file; and
logic configured to copy identified files into the output file to obtain a new disk image.

17. The builder of claim 16, wherein the logic configured to creating file system structures comprises logic configured to create at least one of a file allocation table, a master boot record, and a root directory.

18. The builder of claim 16, wherein the logic configured to copy identified files comprises logic configured to read each identified file and copy file blocks to the output file.

19. The builder of claim 16, further comprising logic configured to insert file attribute data into the file system structures including at least one of file names, file types, and file sizes.

20. A computer system, comprising:
a processing device; and
memory including a disk image builder, the image builder being configured to receive identification of individual files separate from an existing disk image, to create file system structures within an output file, to insert file attribute data into the file system structures, and to copy the individual files into the output file to generate a new disk image.

21. The system of claim 20, wherein the disk image builder is configured to create at least one of a file allocation table, a master boot record, and a root directory.
